(19) United States
(12) Patent Application Publication
(10) Pub. No.: US 2015/0094056 A1
(43) Pub. Date: Apr. 2, 2015

(54) SATELLITE COMMUNICATION SYSTEM AND METHOD FOR ADAPTIVE CHANNEL ASSIGNMENT

(71) Applicant: Electronics and Telecommunications Research Institute, Daejeon (KR)

(72) Inventor: Dae Sub OH, Daejeon (KR)

(21) Appl. No.: 14/493,798

(22) Filed: Sep. 23, 2014

(30) Foreign Application Priority Data
Oct. 1, 2013 (KR) 10-2013-0117279
Feb. 11, 2014 (KR) 10-2014-0015585

(51) Int. Cl. H04B 7/185; H04W 24/08; H04W 72/08

(52) U.S. Cl. CPC H04B 7/18539; H04W 72/082; H04W 24/08; H04B 7/1858
USPC 455/430; 455/427; 455/12.1

(57) ABSTRACT

A satellite communication system and method for an adaptive channel assignment is disclosed in which the satellite communication apparatus include a satellite beam generator to generate a satellite beam to be output to a coverage area, a channel assignor to assign a channel for the satellite beam based on interference information of the coverage area, and a communication link forming unit to form a communication link with an earth station disposed in the coverage area based on the assigned channel.

### CROSS-REFERENCE TO RELATED APPLICATIONS

This application claims the priority benefit of Korean Patent Application No. 10-2013-0117279, filed on Oct. 1, 2013, and Korean Patent Application No. 10-2014-0015585, filed on Feb. 11, 2014, in the Korean Intellectual Property Office, the disclosures of which are incorporated herein by reference.

### BACKGROUND

1. Field of the Invention

Embodiments of the present invention relate to a satellite communication system and method for adaptive channel assignment, and more particularly, to a satellite communication system and method of determining a channel to be assigned to a satellite beam based on mitigation of the radio interference in a satellite coverage area of the satellite communication system.

2. Description of the Related Art A satellite communication system using multiple beams may include a plurality of satellite coverage areas each of which outputs a satellite beam. For example, the satellite communication system may use differing frequency bands for a plurality of beams, and re-use a frequency band for a different beam in order to enhance frequency efficiency.

In a current state of frequency distribution, an identical frequency band may be shared by a satellite network and a terrestrial network. Accordingly, a terrestrial network having a channel in a frequency band identical to a satellite beam may exist in a satellite coverage area. In this instance, radio interference may occur between the satellite beam and a wireless signal of the terrestrial network.

A conventional satellite communication system arbitrarily assigns channels in an available frequency band to satellite beams. Thus, a channel assigned to a satellite beam by the conventional satellite communication system is likely to be identical to a channel in a frequency band used in the terrestrial network. When the channel assigned to the satellite beam is identical to the channel in the frequency band used in the terrestrial network, an error may occur in a satellite service due to radio interference of the terrestrial network.

Accordingly, there is a need for a method of avoiding interference between the terrestrial network and the satellite network.

### SUMMARY

An aspect/embodiment of the present invention provides an apparatus and a method of avoiding interference between a satellite beam and a wireless signal used by a different wireless system disposed in a satellite coverage area.

According to an aspect of the present invention, there is provided a satellite communication apparatus, the apparatus including a beam generator to generate a satellite beam to be output to a satellite coverage area, a channel assignor to assign a channel for the satellite beam based on interference information of the satellite coverage area, and a communication link forming unit to form a communication link with an earth station disposed in the satellite coverage area based on the assigned channel.

The channel assignor may assign, to the satellite beam, a channel differing from the channel used for the wireless communication in the satellite coverage area.

The channel assignor may select a channel to minimize interference with respect to the satellite coverage area, and assign the selected channel to the satellite beam.

The satellite communication apparatus may further include a monitoring unit to monitor the interference information, wherein the channel assignor re-assigns a channel for the satellite beam based on a change in the monitored interference information.

According to an aspect of the present invention, there is provided a satellite control apparatus, the apparatus including a channel assignor to assign a channel for a satellite beam to be output to a satellite coverage area based on interference information of the satellite coverage area, and a satellite communication apparatus controller to control a satellite communication apparatus to output a satellite beam to the assigned channel, and form a communication link between an earth station in the satellite coverage area and the satellite communication apparatus.

According to an aspect of the present invention, there is provided an earth station, including an interference information generator to generate interference information by measuring a level of interference between a channel used for wireless communication in a satellite coverage area and a channel assigned to a satellite beam, an interference information transmitter to transmit the interference information to a satellite communication apparatus, and a communication link forming unit to receive, from the satellite communication apparatus, a satellite beam to which a channel is assigned based on the interference information, and form a communication link with the satellite communication apparatus using the received satellite beam.

According to an aspect of the present invention, there is provided a satellite communication method, the method including generating a satellite beam to be output to a satellite coverage area, assigning a channel for the satellite beam based on interference information of the satellite coverage area, and forming a communication link with an earth station disposed in the satellite coverage area based on the assigned channel.

According to an aspect of the present invention, there is provided a satellite control method, the method including assigning a channel for a satellite beam to be output to a satellite coverage area based on interference information of the satellite coverage area, and controlling a satellite communication apparatus to output a satellite beam to the assigned channel, and form a communication link between an earth station of the satellite network and the satellite communication apparatus.

According to an aspect of the present invention, there is provided an operating method of an earth station, the method including generating interference information by measuring interference between a channel used for wireless communication in a satellite coverage area and a channel assigned to a satellite beam, transmitting the interference information to a satellite communication apparatus, and receiving, from the satellite communication apparatus, the satellite beam to which the channel is assigned based on the interference information, and forming a communication link with the satellite communication apparatus using the received satellite beam.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a satellite communication system according to an embodiment of the present invention;

FIG. 2 is a diagram illustrating a satellite communication system in a related art;

FIG. 3 is a diagram illustrating an example of interference occurring in a satellite communication system in a related art;

FIG. 4 is a diagram illustrating a satellite communication apparatus according to an embodiment of the present invention;

FIG. 5 is a diagram illustrating an earth station according to an embodiment of the present invention;

FIG. 6 is a diagram illustrating a satellite control apparatus according to an embodiment of the present invention;

FIG. 7 is a diagram illustrating an example of a satellite communication system according to an embodiment of the present invention;

FIG. 8 is a flowchart illustrating a satellite communication method according to an embodiment of the present invention;

FIG. 9 is a diagram illustrating a configuration operation of a satellite communication system according to an embodiment of the present invention; and

FIG. 10 is a diagram illustrating a configuration operation of a satellite communication system according to another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures. According to an aspect of the present exemplary embodiment, a satellite communication method may be performed by a satellite communication apparatus.

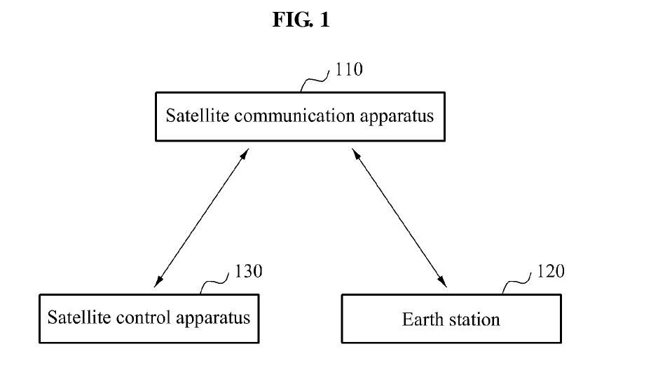

FIG. 1 is a diagram illustrating a satellite communication system according to an embodiment of the present invention.

Referring to FIG. 1, the satellite communication system includes a satellite communication apparatus 110, an earth station 120, and a satellite control apparatus 130.

The satellite communication apparatus 110 may refer to a wireless apparatus provided external to an atmosphere of the earth to perform satellite communication with the earth station 120 on a surface of the earth. As used herein, the satellite communication apparatus 110 may refer to a space station provided in a satellite or a space shuttle. For example, the satellite communication apparatus 110 generates multiple satellite beams, outputs the generated satellite beams to differing satellite coverage areas, and forms a communication link with the earth station 120 disposed within a satellite coverage area. The satellite communication apparatus 110 communicates sound and information with the earth station 120 via the formed communication link.

In this example, the satellite communication apparatus 110 assigns a channel for a satellite beam based on interference information of a satellite coverage area received from the earth station 120. As used herein, the interference information may refer to information to be determined based on a channel used for wireless communication in the satellite coverage area in which the earth station 120 is disposed. For example, the satellite communication apparatus 110 recognizes radio interference occurring in the satellite coverage area in which the earth station 120 is disposed based on frequency usage information and interference information within a coverage area received from the earth station 120, and assigns the channel for the satellite beam to minimize the radio interference occurring in the satellite coverage area in which the earth station 120 is disposed.

When the satellite control apparatus 130 assigns the channel for the satellite beam based on the interference information, the satellite communication apparatus 110 forms a communication link between the earth station 120 and the satellite communication apparatus 110 using a frequency channel assigned to the satellite beam based on remote control of the satellite control apparatus 130.

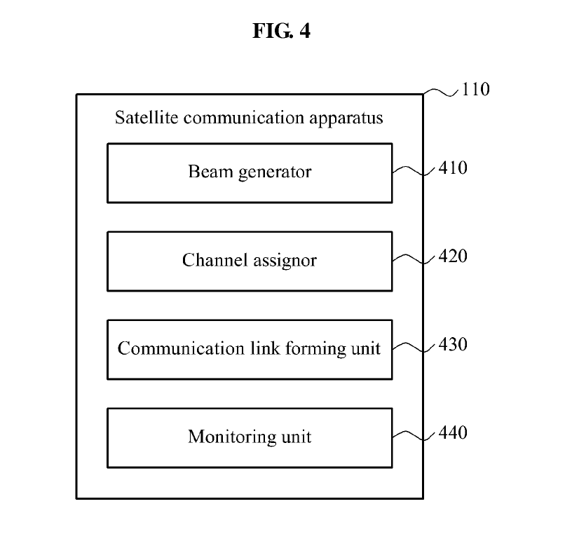

Descriptions pertaining to a configuration and an operation of the satellite communication apparatus 110 will be provided in greater detail with reference to FIG. 4.

The earth station 120 disposed on a surface of the earth may refer to a wireless apparatus to perform satellite communication with the satellite communication apparatus 110. For example, the earth station 120 may include a fixed-type earth station provided on a predetermined position and a mobile-type earth station.

The earth station 120 forms a communication link with another earth station via the satellite communication apparatus 110. For example, the satellite communication apparatus 110 forms the communication link between the earth station 120 and the other earth station by connecting a communication link between the earth station 120 and the satellite communication apparatus 110 to a communication link between the other earth station and the satellite communication apparatus 110. In this example, the earth station 120 communicates sound and information with the other earth station using the communication link between the earth station 120 and the other earth station.

The earth station 120 forms a communication link with the satellite control apparatus 130 via the satellite communication apparatus 110. In this example, the satellite control apparatus 130 connects to another communication network using a switching system. For example, the earth station 120 forms a communication link with a terminal or a base station in the other communication network via the switching system of the satellite control apparatus 130 that forms a communication link. The earth station 120 communicates sound and information with the terminal or the base station of the other communication network using the formed communication link.

The earth station 120 generates interference information based on the satellite coverage area in which the earth station 120 is disposed. For example, the earth station 120 measures a level of interference between a channel used for wireless communication by a wireless network differing from a satellite network of the satellite communication system in the satellite coverage area in which the earth station 120 is disposed, and a channel assigned to the satellite beam by the satellite communication apparatus 110. The earth station 120 generates the frequency usage information and the interference information in the satellite beam based on a result of the measurement, and transmits the information to the satellite communication apparatus 110 or the satellite control apparatus 130. For example, when a channel used for wireless communication by a terrestrial network, such as a cellular system or a fixed microwave wireless base station overlaps a channel assigned to the satellite beam by the satellite communication apparatus 110, interference may occur between the terrestrial network and the satellite network of the satellite communication system. In this example, the earth station 120 generates interference information by measuring the frequency usage information of the terrestrial network and interference between the terrestrial network and the satellite network.

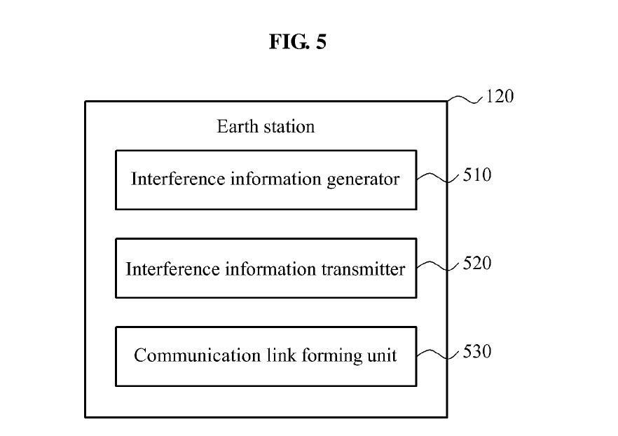

Description pertaining to a configuration and an operation of the earth station 120 will be provided in greater detail with reference to FIG. 5.

The satellite control apparatus 130 remotely controls the satellite communication apparatus 110. For example, the satellite control apparatus 130 assigns a channel to a satellite beam to be output to a satellite coverage area based on interference information. The satellite control apparatus 130 forms a communication link between the earth station 120 disposed in the satellite coverage area and the satellite communication apparatus 110 by controlling the satellite communication apparatus 110 to output the satellite beam to the assigned channel.

The satellite control apparatus 130 forms a communication link with the earth station 120 via the satellite communication apparatus 110. For example, the satellite communication apparatus 110 forms the communication link between the satellite control apparatus 130 and the earth station 120 by connecting a communication link between the satellite control apparatus 130 and the satellite communication apparatus 110 to the communication link between the earth station 120 and the satellite communication apparatus 110.

The satellite control apparatus 130 includes a switching system, and connects a satellite network and another communication network, such as a public switched telephone network (PSTN) using the switching system. For example, the satellite control apparatus 130 may refer to a gateway earth station.

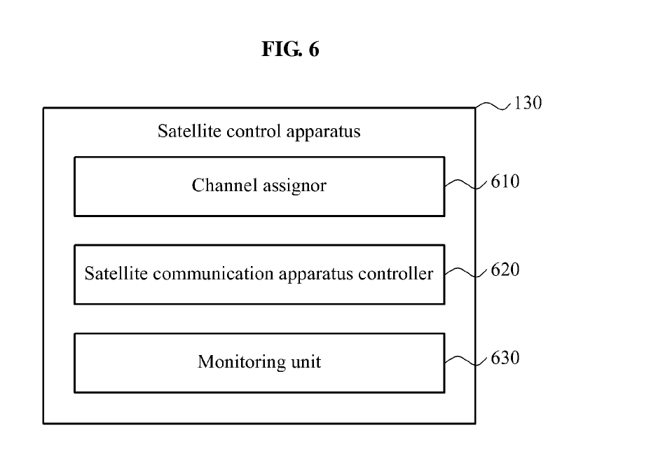

Descriptions pertaining to a configuration and an operation of the satellite control apparatus 130 will be provided in greater detail with reference to FIG. 6.

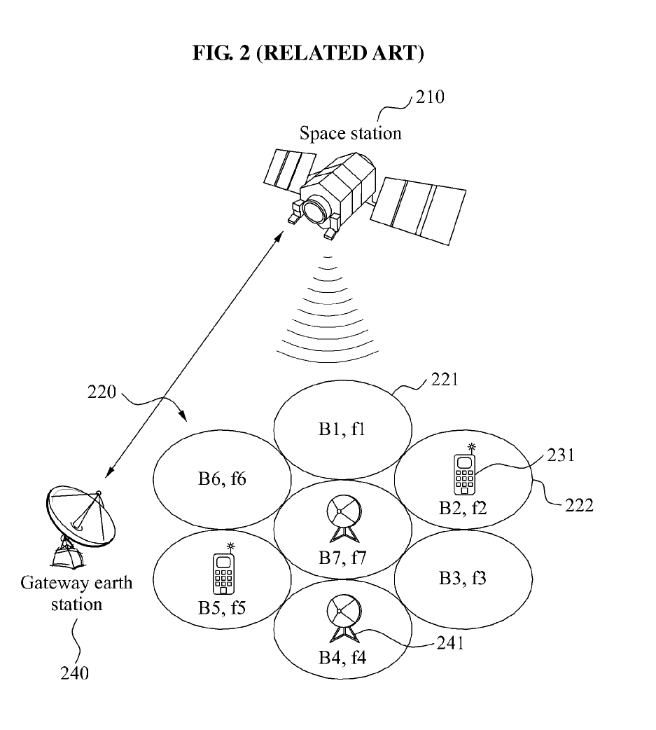

FIG. 2 is a diagram illustrating a satellite communication system in a related art.

A space station 210 of the satellite communication system provided external to an atmosphere of the earth generates multiple satellite beams corresponding to each of a plurality of satellite coverage areas 220 and outputs the satellite beams. For example, the space station 210 outputs a satellite beam B1 to a satellite coverage area 221, and outputs a satellite beam B2 to a satellite coverage area 222. When a total frequency band used by the space station 210 is F, and a frequency re-use rate is “7”, the space station 210 assigns frequency channels f1 through f7 to satellite beams B1 through B7, respectively, to output the satellite beams.

For example, the space station 210 may enhance efficiency in frequency utilization based on a frequency re-use technique by assigning differing channels in frequency bands to the satellite beams B1 through B7. An earth station of the satellite communication system forms a communication link with the space station 210 by receiving a satellite beam output to a satellite coverage area in which the earth station is disposed. In this example, the earth station is classified into a mobile-type earth station 231 or a fixed-type earth station 232 based on a type of satellite communication services. A user may use sound and information communication via the earth station. For example, the earth station forms a communication link with another earth station via the space station 210, and communicates sound and information with the other earth station.

The earth station forms a communication link with a gateway earth station 240 via the space station 210. The gateway earth station 240 may refer to an earth station including a switching system, and connect to a satellite network and a communication network different from a satellite network, for example, another earth station. The gateway earth station 240 controls an operation of the space station 210 and the earth station, and operates an accounting system.

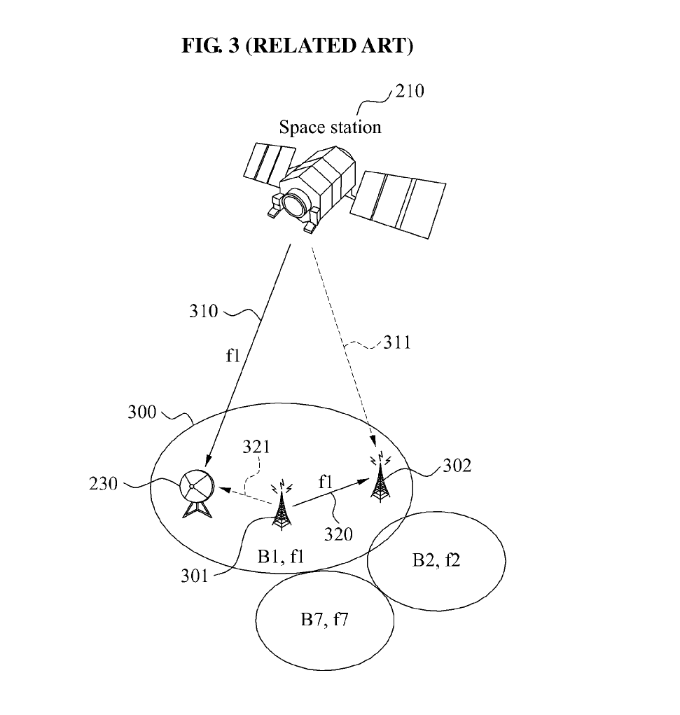

FIG. 3 is a diagram illustrating an example of interference occurring in a satellite communication system in a related art.

A satellite network of the satellite communication system has a wider service area than a terrestrial network. Accordingly, at least one different wireless communication system may operate in a satellite coverage area that provides the satellite network. For example, a first base station 301 to perform wireless communication with a second base station 302 using a channel f1 may exist in a satellite coverage area 300. A satellite beam B1 310 to which the channel f1 is assigned is output from the satellite coverage area 300.

In this example, the satellite beam 310 received by an earth station 230 is interfered 321 by a wireless signal 320 of the channel f1 output from the first base station 301. The wireless signal 320 of the channel f1 received by a second base station 302 is also experiences interference 311 from the satellite beam B1 310 to which the channel f1 is assigned. However, in the conventional satellite communication system, a single satellite beam uses a single channel irrespective of a presence of interference because a channel to be assigned to a satellite beam is fixed in the conventional satellite communication system. Accordingly, when the channel assigned to the satellite beam overlaps a channel used for wireless communication of a satellite coverage area, an error may occur due to interference between the wireless communication and satellite communication.

FIG. 4 is a diagram illustrating a satellite communication apparatus according to an embodiment of the present invention.

Referring to FIG. 4, the satellite communication apparatus 110 includes a beam generator 410, a channel assignor 420, a communication link forming unit 430, and a monitoring unit 440.

The beam generator 410 generates a satellite beam to be output to a satellite coverage area that provides a satellite communication service. Here, the beam generator 410 generates multiple satellite beams corresponding to each of a plurality of satellite coverage areas.

The channel assignor 420 assigns a channel for the satellite beam generated by the beam generator 410 based on interference information of a satellite coverage area received from the earth station 120. In this example, the channel assignor 420 selects a channel to minimize interference with respect to the satellite coverage area using an optimum assignment algorithm, and assigns the selected channel to the channel for the satellite beam. In detail, the channel assignor 420 avoids interference between a channel used for wireless communication in the satellite coverage area and the channel for the satellite beam by recognizing the channel used for the wireless communication in the satellite coverage area based on the interference information, and assigning a channel differing from the channel used for the wireless communication in the satellite coverage area to the satellite beam. By way of example, the channel assignor 420 recognizes that the channel used by a wireless network, differing from a wireless network using a satellite beam, for example, a terrestrial network in a satellite coverage area, for the wireless communication in the satellite coverage area is a channel f2 by analyzing the interference information. The channel assignor 420 assigns remaining channels aside from the channel f2 in a frequency band to the channel for the satellite beam. When the channel for the satellite beam differs from the channel used by the different wireless network for the wireless communication, interference between the channel for the satellite beam and the channel used by the different wireless network for the wireless communication may not occur. Accordingly, the channel assignor 420 avoids interference between a satellite network and a wireless network, differing from a wireless network using a satellite beam, for example, a terrestrial network in a satellite coverage area, by assigning the channel for the satellite beam from among the remaining channels aside from the channel used by the different wireless network for the wireless communication in the frequency band.

Also, interference may occur in each satellite coverage area from which a plurality of satellite beams is to be output. In a single satellite coverage area, a plurality of wireless networks may use differing channels. In this example, the channel assignor 420 assigns a channel to each of the satellite beams to minimize interference among satellite beams generated by the beam generator 410 based on interference information received from earth stations disposed in each of a plurality of satellite coverage areas.

The communication link forming unit 430 forms a communication link with the earth station 120 disposed in the satellite coverage area based on the channel assigned by the channel assignor 420. For example, the communication link forming unit 430 outputs a satellite beam generated by the beam generator 410 to the satellite coverage area using the channel assigned by the channel assignor 420. The earth station 120 disposed in the satellite coverage area receives the satellite beam, and forms the communication link between the satellite communication apparatus 110 and the earth station 120 through the satellite beam.

The monitoring unit 440 monitors the interference information received by the channel assignor 420. For example, the monitoring unit 440 monitors whether interference information currently received by the channel assignor 420 changes from interference information previously received by the channel assignor 420. When the currently received interference information differs from the previously received interference information, the channel assignor 420 updates the interference information to the currently received interference information. The channel assignor 420 re-assigns a channel for a satellite beam based on the updated interference information. The monitoring unit 440 updates existing interference information using interference information received at predetermined intervals.

For example, the channel assignor 420 assigns a default channel pre-set at an initial operation of the satellite communication apparatus 110 to the channel for the satellite beam. The communication link forming unit 430 outputs the satellite beam to the satellite coverage area using the default channel.

The channel assignor 420 receives, from the earth station 120 in the satellite coverage area, interference information associated with the satellite beam output using the default channel.

The channel assignor 420 changes a channel to be assigned to the satellite beam based on the received interference information. In this example, the communication link forming unit 430 outputs the satellite beam to the satellite coverage area using the changed channel.

The satellite communication apparatus 110 minimizes interference between a channel assigned to a satellite beam and a channel used by a different wireless network for wireless communication in a satellite coverage area by adaptively assigning and re-assigning a channel to a satellite beam through iteration of the above process.

In an on board processing technology, the satellite communication apparatus 110 includes the channel assignor 420 to assign a channel to a satellite beam. The satellite communication apparatus 110 forms a communication link with the earth station 120 disposed in the satellite coverage area based on control of the satellite control apparatus 130. For example, the satellite communication apparatus 110 receives a channel for a satellite beam from the satellite control apparatus 130. The satellite communication apparatus 110 outputs a satellite beam generated by the beam generator 410 to the satellite coverage area using the received channel. In this example, the satellite communication apparatus 110 may not include the channel assignor 420 and the monitoring unit 440 because operations of the channel assignor 420 and the monitoring unit 440 are performed by the satellite control apparatus 130.

FIG. 5 is a diagram illustrating the earth station 120 according to an embodiment of the present invention.

Referring to FIG. 5, the earth station 120 includes an interference information generator 510, an interference information transmitter 520, and a communication link forming unit 530.

The interference information generator 510 generates interference information by measuring interference between a channel used for wireless communication in a satellite coverage area and a channel assigned to a satellite beam. In this example, the interference information generator 510 collects the channel used for the wireless communication in the satellite coverage area, and measures the level of the interference between the collected channel and the channel assigned to the satellite beam. The interference information generator 510 generates the interference information including the collected channel and a result of the interference measurement.

The interference information transmitter 520 transmits the interference information generated by the interference information generator 510 to the satellite communication apparatus 110. In this example, the satellite communication apparatus 110 transmits the interference information received from the interference information transmitter 520 to the satellite control apparatus 130, receives, from the satellite control apparatus 130, a channel to be assigned to a satellite beam based on the interference information, and outputs the satellite beam to which the received channel is assigned.

The interference information transmitter 520 transmits the interference information generated by the interference information generator 510 to the satellite control apparatus 130 via the satellite communication apparatus 110. In this example, the satellite control apparatus 130 determines the channel to be assigned to the satellite beam based on the interference information, and transmits the determined channel to the satellite communication apparatus 110. The satellite communication apparatus 110 outputs the satellite beam to which the received channel is assigned.

The communication link forming unit 530 receives, from the satellite communication apparatus 110, the satellite beam to which the channel is assigned based on the interference information, and forms a communication link with the satellite communication apparatus 110 using the received satellite beam.

FIG. 6 is a diagram illustrating the satellite control apparatus 130 according to an embodiment of the present invention.

Referring to FIG. 6, the satellite control apparatus 130 includes a channel assignor 610, a satellite communication apparatus controller 620, and a monitoring unit 630.

The channel assignor 610 assigns a channel to a satellite beam to be output to a satellite coverage area based on interference information of the satellite coverage area. In this example, the channel assignor 610 assigns, to the satellite beam, a channel differing from a channel used for wireless communication in the satellite coverage area.

The satellite communication apparatus controller 620 controls the satellite communication apparatus 110 to output a satellite beam using the channel assigned by the channel assignor 610. In this example, the satellite communication apparatus 110 outputs the satellite beam based on control of the satellite communication apparatus controller 620, and forms a communication link between an earth station of the satellite coverage area and the satellite communication apparatus 110.

The monitoring unit 630 monitors interference information received by the channel assignor 610. For example, the monitoring unit 630 monitors whether interference information currently received by the channel assignor 610 differs from interference information previously received by the channel assignor 610. When the currently received interference information differs from the previously received interference information, the channel assignor 610 updates the interference information to the currently received interference information. The channel assignor 610 re-assigns a channel for a satellite beam based on the updated interference information.

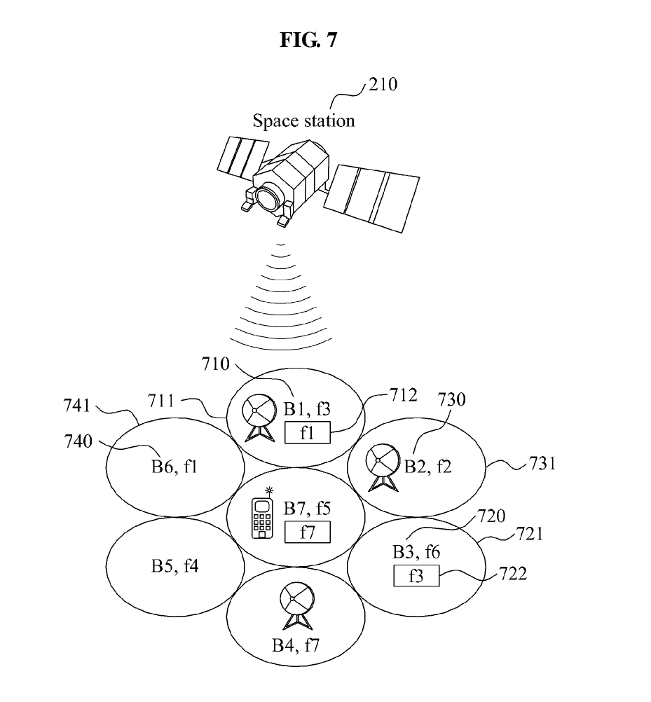

FIG. 7 is a diagram illustrating an example of a satellite communication system according to an embodiment of the present invention.

A communication system T1 712 to perform wireless communication in a terrestrial network using a channel f1 disposed in a satellite coverage area 711 from which a satellite beam B1 710 is output. The space station 210 assigns the channel f1 as a default channel to the satellite beam B1 710, and outputs the channel f1. In this example, interference may occur between the satellite beam B1 710 and a wireless signal used for wireless communication by the communication system T1 712.

An earth station disposed in the satellite coverage area 711 measures a level of the interference between the satellite beam B1 710 and the wireless signal used for the wireless communication by the communication system T1 712, generates interference information based on a result of the measurement, and transmits the interference information to the space station 210.

The space station 210 performs a channel assignment algorithm to minimize interference within the satellite coverage area based on the received interference information. The space station 210 assigns a frequency channel to minimize the interference within the satellite coverage area to each of a plurality of satellite beams.

For example, the space station 210 avoids the interference between the satellite beam B1 710 and the wireless signal used for the wireless communication by the communication system T1 712 by re-assigning a channel f3 to the satellite beam B1 710. Also, a communication system T2 722 to perform wireless communication using the channel f3 exists in a satellite coverage area 721 from which a satellite beam B3 720 is output. In this example, interference may occur between the satellite beam B3 720 and a wireless signal used for wireless communication by the communication system T2 722 because the channel f3 is assigned as a default channel to the satellite beam B3 720. Accordingly, the space station 210 avoids the interference between the satellite beam B3 720 and the wireless signal used for the wireless communication by the communication system T2 722 by re-assigning a channel f6 to the satellite beam B3 720. A satellite beam B6 740 to which the channel f6 is assigned as a default channel may not have an assigned channel because the channel f6 assigned as the default channel is re-assigned to the satellite beam B3 720. As a result, the space station 210 re-assigns, to the satellite beam B6 740, the channel f1 that is not assigned to the satellite beam B1 710 and the satellite beam B2 720. In this example, interference may not occur in a coverage area 741 from which the satellite beam B6 740 is to be output because another communication system that uses the channel f1 is absent in the coverage 741. In a coverage area 731 from which a satellite beam B2 730 is to be output, another communication system that uses the channel f2 is absent as shown in FIG. 7. In this example, the space station 210 may not change the channel assigned to the satellite beam B2 730.

The space station 210 avoids interference between a channel assigned to a plurality of satellite beams and a channel of a wireless signal used by a different wireless system by re-assigning the channel to the plurality of satellite beams based on the channel assigned to the plurality of satellite beams and the channel used by the different wireless system within a coverage area from which the plurality of satellite beams is output.

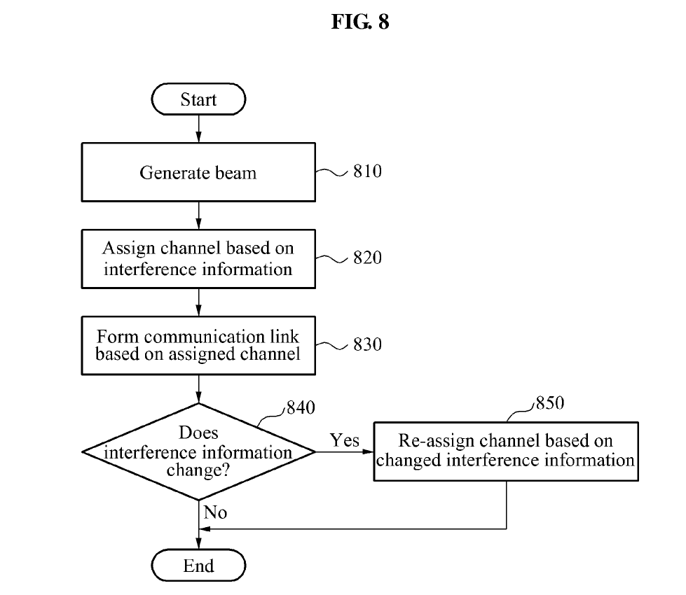

FIG. 8 is a flowchart illustrating a satellite communication method according to an embodiment of the present invention.

In operation 810, the beam generator 410 generates a satellite beam to be output to a satellite coverage area that provides a satellite communication service. Here, the beam generator 410 generates multiple satellite beams corresponding to each of a plurality of satellite coverage areas.

In operation 820, the channel assignor 420 assigns a channel for the satellite beam generated in operation 810 based on interference information of a satellite coverage area received from the earth station 120. In this example, the channel assignor 420 selects a channel to minimize interference with respect to the satellite coverage area using an optimum assignment algorithm, and assigns the selected channel to the channel for the satellite beam.

In operation 830, the communication link forming unit 430 forms a communication link with the earth station 120 disposed in a satellite coverage area based on the channel assigned in operation 820. For example, the communication link forming unit 430 outputs a satellite beam generated by the beam generator 410 to the satellite coverage area using the channel assigned by the channel assignor 420. The earth station 120 disposed in the satellite coverage area receives the satellite beam, and forms the communication link between the satellite communication apparatus 110 and the earth station 120 through the satellite beam.

In operation 840, the monitoring unit 440 monitors whether interference information currently received by the channel assignor 420 differs from interference information previously received by the channel assignor 420.

When the currently received interference information changes, the monitoring unit 440 controls the channel assignor 420 to update the interference information to the currently received interference information and perform operation 850. When the currently received interference information does not change, the monitoring unit 440 ends an operation.

In operation 850, the channel assignor 420 re-assigns a channel for a satellite beam based on the interference information updated in operation 840.

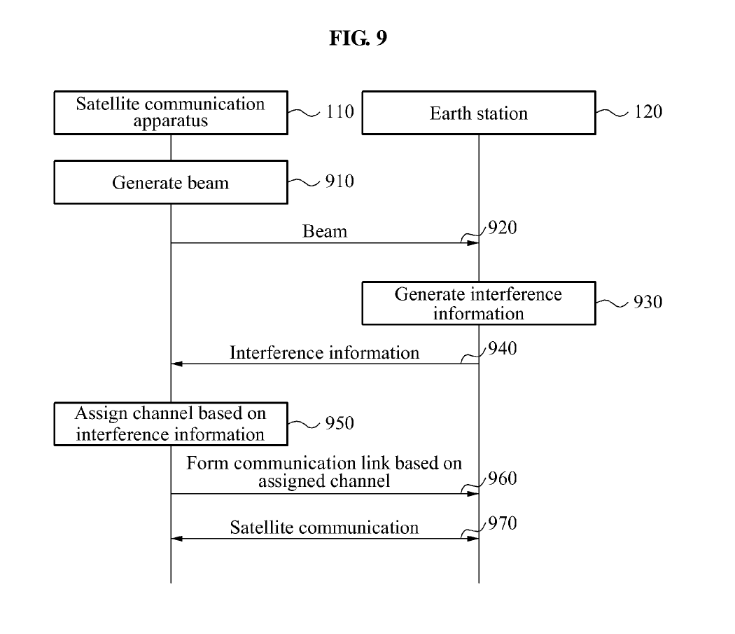

FIG. 9 is a diagram illustrating a configuration operation of a satellite communication system according to an embodiment of the present invention.

FIG. 9 illustrates an example of an operation of the satellite communication system in which the satellite communication apparatus 110 assigns a channel to a satellite beam.

In operation 910, the beam generator 410 of the satellite communication apparatus 110 generates a satellite beam to be output to a satellite coverage area that provides a satellite communication service. The channel assignor 420 of the satellite communication apparatus 110 assigns a pre-set default channel to a channel for the generated satellite beam.

In operation 920, the communication link forming unit 430 of the satellite communication apparatus 110 outputs the satellite beam to the satellite coverage area using the default channel assigned in operation 910.

In operation 930, the interference information generator 510 of the earth station 120 measures a level of interference between the satellite beam output in operation 920 and a channel used for wireless communication in a coverage area in which the earth station 210 is disposed, and generates interference information based on a result of the measurement. In this example, the interference information generator 510 collects the channel used for the wireless communication in the satellite coverage area, and measures the interference between the collected channel and the channel assigned to the satellite beam. The interference information generator 510 generates the interference information including the collected channel and the result of the interference measurement.

In operation 940, the interference information transmitter 520 of the earth station 120 transmits the interference information generated in operation 930 to the satellite communication apparatus 110.

In operation 950, the channel assignor 420 of the satellite communication apparatus 110 assigns the channel for the satellite beam based on the interference information received in operation 940. For example, the channel assignor 420 selects a channel to minimize interference with respect to the satellite coverage area based on the received interference information, and re-assigns the selected channel to the channel for the satellite beam.

In operation 960, the communication link forming unit 430 of the satellite communication apparatus 110 forms a communication link with the earth station 120 disposed in the satellite coverage area based on the channel assigned in operation 950. For example, the communication link forming unit 430 assigns the channel selected in operation 950 to the satellite beam, and outputs the channel to the satellite coverage area.

In operation 970, the communication link forming unit 430 of the earth station 120 performs satellite communication between the satellite communication apparatus 110 and the earth station 120 through the satellite beam received in operation 960.

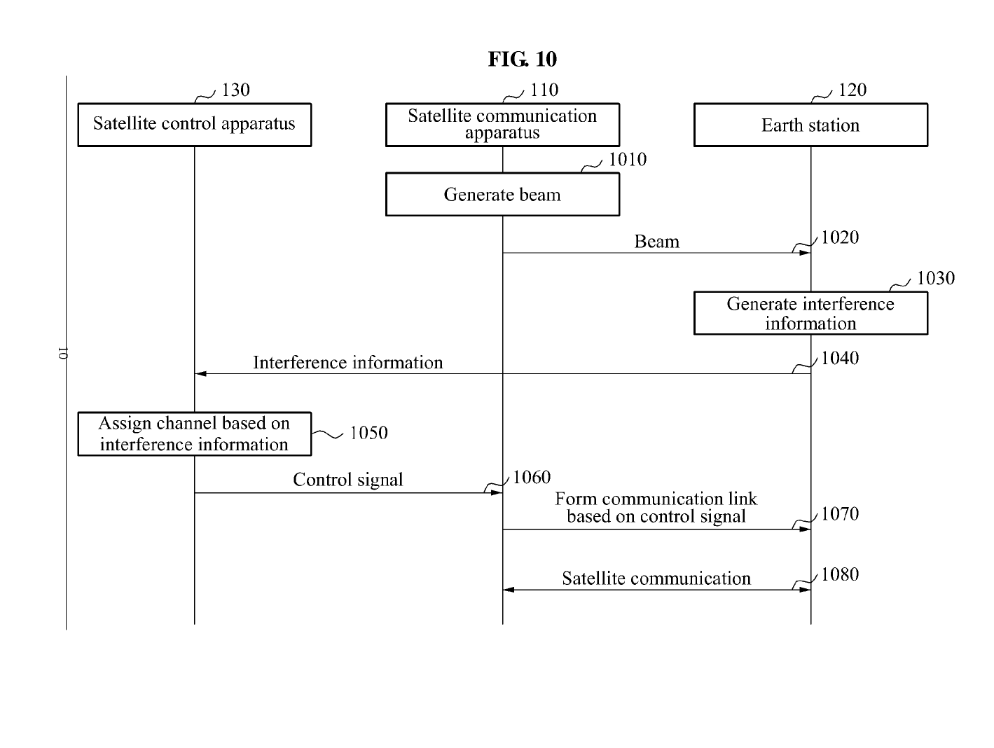

FIG. 10 is a diagram illustrating a configuration operation of a satellite communication system according to another embodiment of the present invention.

FIG. 10 illustrates an example of an operation of the satellite communication system in which the satellite control apparatus 130 performs satellite communication by assigning a channel to a satellite beam, and remotely controlling the satellite communication apparatus 110.

In operation 1010, the beam generator 410 of the satellite communication apparatus 110 generates a satellite beam to be output to a satellite coverage area that provides a satellite communication service. The channel assignor 420 of the satellite communication apparatus 110 assigns a pre-set default channel to a channel for the generated satellite beam.

In operation 1020, the communication link forming unit 430 of the satellite communication apparatus 110 outputs the satellite beam to the satellite coverage area using the default channel assigned in operation 1010.

In operation 1030, the interference information generator 510 of the earth station 120 measures a level of interference between the satellite beam output in operation 1020 and a channel used for wireless communication in a coverage area in which the earth station 210 is disposed, and generates interference information based on a result of the measurement. In this example, the interference information generator 510 collects the channel used for the wireless communication in the satellite coverage area, and measures the level of the interference between the collected channel and the channel assigned to the satellite beam. The interference information generator 510 generates the interference information including the collected channel and the result of the interference measurement.

In operation 1040, the interference information transmitter 520 of the earth station 120 transmits the interference information generated in operation 1030 to the satellite communication apparatus 110. In this example, the satellite communication apparatus 110 transmits the interference information received from the interference information transmitter 520 to the satellite control apparatus 130.

In operation 1050, the channel assignor 610 of the satellite control apparatus 130 assigns the channel for the satellite beam based on the interference information received in operation 1040. For example, the channel assignor 610 selects a channel to minimize interference with respect to the satellite coverage area based on the received interference information, and re-assigns the selected channel to the channel for the satellite beam.

In operation 1060, the satellite communication apparatus controller 620 of the satellite control apparatus 130 transmits a control signal to the satellite communication apparatus 110. As used herein, the control signal may refer to a signal to remotely control the satellite communication apparatus 110 to assign the channel for the satellite beam determined in operation 1050 to the plurality of satellite beams and output the channel.

In operation 1070, the communication link forming unit 430 of the satellite communication apparatus 110 forms a communication link with the earth station 120 to disposed in the satellite coverage area based on the control signal received in operation 1060. For example, the communication link forming unit 430 assigns the channel selected in operation 1050 to the satellite beam based on the control signal received in operation 1060, and outputs the satellite beam to which the channel is assigned to the satellite coverage area.

In operation 1080, the communication link forming unit 430 of the earth station 120 performs satellite communication between the satellite communication apparatus 110 and the earth station 120 through the satellite beam received in operation 1070.

According to an aspect of the present invention, it is possible to avoid interference between a satellite beam and a wireless signal used by a wireless system differing from a wireless network using a satellite beam, for example, a terrestrial network disposed in a satellite coverage area, by determining a channel to be assigned to the satellite beam using interference information of the satellite coverage area from which the satellite beam is output.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A satellite communication apparatus, the apparatus comprising:
a beam generator to generate a satellite beam to be output to a satellite coverage area;
a channel assignor to assign a channel for the satellite beam based on interference information of the satellite coverage area; and
a communication link forming unit to form a communication link with an earth station disposed in the satellite coverage area based on the assigned channel.

2. The apparatus of claim 1, wherein the earth station measures a level of interference between a channel used for wireless communication in the satellite coverage area and the channel assigned to the satellite beam, generates interference information, and transmits the generated interference information to the channel assignor.

3. The apparatus of claim 2, wherein the channel assignor assigns, to the satellite beam, a channel differing from the channel used for the wireless communication in the satellite coverage area.

4. The apparatus of claim 1, wherein the channel assignor selects a channel to minimize interference with respect to the satellite coverage area, and assigns the selected channel to the satellite beam.

5. The apparatus of claim 1, further comprising:
a monitoring unit to monitor the interference information,
wherein the channel assignor re-assigns a channel for the satellite beam based on a change in the monitored interference information.

6. A satellite control apparatus, the apparatus comprising:
a channel assignor to assign a channel for a satellite beam to be output to a satellite coverage area based on interference information of the satellite coverage area; and
a satellite communication apparatus controller to control a satellite communication apparatus to output a satellite beam to the assigned channel, and form a communication link between an earth station in the satellite coverage area and the satellite communication apparatus.

7. The apparatus of claim 6, wherein the earth station measures a level of interference between a channel used for wireless communication in the satellite coverage area and the channel assigned to the satellite beam, generates interference information, and transmits the generated interference information to the channel assignor.

8. The apparatus of claim 6, wherein the channel assignor assigns, to the satellite beam, a channel differing from the channel used for the wireless communication in the satellite coverage area.

9. The apparatus of claim 6, further comprising:
a monitoring unit to monitor the interference information,
wherein the channel assignor re-assigns a channel for the satellite beam based on a change in the monitored interference information.

10. An earth station, comprising:
an interference information generator to generate interference information by measuring a level of interference between a channel used for wireless communication in a satellite coverage area and a channel assigned to a satellite beam;
an interference information transmitter to transmit the interference information to a satellite communication apparatus; and
a communication link forming unit to receive, from the satellite communication apparatus, a satellite beam to which a channel is assigned based on the interference information, and form a communication link with the satellite communication apparatus using the received satellite beam.

11. The earth station of claim 10, wherein the satellite communication apparatus selects a channel to minimize interference with respect to the satellite coverage area based on the received interference information, and assigns the selected channel to the satellite beam.

12. The earth station of claim 10, wherein the satellite communication apparatus transmits the received interference information to a satellite control apparatus, receives, from the satellite control apparatus, a channel to be assigned to the satellite beam based on the interference information, and outputs the satellite beam to which the received channel is assigned.

13. A satellite communication method, the method comprising:
generating a satellite beam to be output to a satellite coverage area;
assigning a channel for the satellite beam based on interference information of the satellite coverage area; and
forming a communication link with an earth station disposed in the satellite coverage area based on the assigned channel.

14. The method of claim 13, wherein the interference information is generated by the earth station measuring a level of interference between a channel used for wireless communication in the satellite coverage area and the channel assigned to the satellite beam.

15. The method of claim 13, wherein the assigning of the channel comprises:
selecting a channel to minimize interference with respect to the satellite coverage area, and assigning the selected channel to the satellite beam.

16. The method of claim 13, further comprising:
monitoring the interference information; and
re-assigning a channel for the satellite beam based on a change in the monitored interference information.

17. A satellite control method, the method comprising:
assigning a channel for a satellite beam to be output to a satellite coverage area based on interference information of the satellite coverage area; and
controlling a satellite communication apparatus to output a satellite beam to the assigned channel and form a communication link between an earth station of the satellite network and the satellite communication apparatus.

18. The method of claim 17, further comprising:
monitoring the interference information; and
re-assigning a channel for the satellite beam based on a change in the monitored interference information.

19. An operating method of an earth station, the method comprising:
generating interference information by measuring interference between a channel used for wireless communication in a satellite coverage area and a channel assigned to a satellite beam;
transmitting the interference information to a satellite communication apparatus; and
receiving, from the satellite communication apparatus, the satellite beam to which the channel is assigned based on the interference information, and forming a communication link with the satellite communication apparatus using the received satellite beam.

20. The method of claim 19, wherein the satellite communication apparatus transmits the received interference information to a satellite control apparatus, receives, from the satellite control apparatus, a channel to be assigned to the satellite beam based on the interference information, and outputs the satellite beam to which the received channel is assigned.
